(19) United States
(12) Patent Application Publication
(10) Pub. No.: US 2006/0224842 A1
(43) Pub. Date: Oct. 5, 2006

(54) Information processor and program preparation method

(75) Inventors: Hiroyuki Suto, Kawasaki (JP); Hiroshi Tsurumi, Kawasaki (JP); Osamu Kawashima, Kawasaki (JP); Katsushi Ohta, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/167,871

(22) Filed: Jun. 27, 2005

(30) Foreign Application Priority Data
Mar. 31, 2005 (JP) 2005-103979

(51) Int. Cl. G06F 12/00

(52) U.S. Cl. 711/156

(57) ABSTRACT

A nonvolatile memory, storing a plurality of access programs for accessing a storage device by the storage device connectable depending on an adopted interface, is comprised in an information processor, when power is applied to the information processor, the types of the adopted interface and connected storage devices are determined, and access programs, except for an access program corresponding to the type specified by the determination, are cleared from the nonvolatile memory. Consequently, the nonvolatile memory can prepare the appropriate access program only.

### BACKGROUND OF THE INVENTION

1. Field of the Invention

The present invention relates to an information processor, on the storage device, comprising an interface to which another storage device is connectable and nonvolatile memory.

2. Description of the Related Art

Booting of an information processor with an MPU comprised on the board is generally performed in the order of initiation of a program on the board by power-on operation and readout and initiation of other programs stored in a storage device by the previously initiated program. In this description, the former program is referred to as “boot code”, and is distinguished from the programs stored in the storage device. The boot code is normally stored in nonvolatile memory such as ROM.

For the storage device, currently, high-capacity storage devices such as hard disk devices are widely adopted. Such storage devices are generally connected to the board by comprising an interface (I/F) on the board. Therefore, in the following description, the term, storage device, is used for a device connected to an interface, unless otherwise noted.

The storage device, which can be connected to an interface, performs communication conforming to interface standards. Many of the devices adopt partly unique specifications. Such circumstances raise a condition that often requires a boot code accessible to the storage device in an information processor with their programs stored in a storage device. By so doing, a nonvolatile memory storing a boot loader supporting a storage device connected to an interface is heretofore comprised on the board.

The adopted storage device normally differs from information processor to information processor. Therefore, writing of the boot code to nonvolatile memory was conventionally performed by arranging special facilities in manufacturing factories and by having personnel write the boot codes, to be written, one by one to the memory.

Arrangement of the special facilities raises manufacturing cost of the information processor. The increase in manufacturing cost is more apparent if the nonvolatile memory is a tape format supporting automatic implementation as it requires troublesome operations such as removing the memory unit, writing the boot code to the memory unit and replacing the memory back in the original position. The memory unit is miniaturized, and thus, has poor workability. From these considerations, in order to reduce manufacturing cost, it is important to eliminate the necessity of personnel writing boot codes appropriate to the storage device to the nonvolatile memory.

It is possible to eliminate the necessity by writing a boot code with a function supporting a plurality of devices in nonvolatile memory, as described in Japanese unexamined patent publication bulletin No. 2004-192341, for example. However, such a multifunctional boot code requires higher-capacity nonvolatile memory for its large data volume, causing an increase in manufacturing cost. Therefore, the important consideration in writing a boot code appropriate to the storage device in nonvolatile memory is not writing a multifunctional boot code but enabling the elimination of writing a conventional boot code. This can be applied to all programs (access programs) for accessing the storage device for booting of information processors. As another technical reference, Japanese unexamined patent publication bulletin No. 2003-280915 should be referred to.

### SUMMARY OF THE INVENTION

It is an object of the present invention to provide a technology to eliminate the necessity of personnel writing to nonvolatile memory an access program which appropriate to a storage device or an interface.

An information processor of the present invention is assumed to comprise an interface to which a storage device can be connected, and the information processor comprises nonvolatile memory, storing an access program for accessing the storage device by a plurality of the connectable interfaces, a type determination unit for determining the interface type and a program selection unit for reading an access program, when powered-on, supporting the type determined by the type determination unit from the nonvolatile memory and for executing the program.

It is desirable that the program selection unit allows only the access program supporting the type determined by the type determination unit to execute by clearing the access programs, except for the access program supporting the type determined by the type determination unit, from the nonvolatile memory when powered on in the state that a plurality of access programs are stored in the nonvolatile memory.

A program preparation method of the present invention is a method for preparing an access program, accessing a storage device connected to an interface comprised in an information processor, in nonvolatile memory comprised in the information processor, and the method loads the nonvolatile memory, storing a plurality of access programs of storage devices connectable by the interface, in the information processor, determines the type of storage device connected to the interface when power is applied to the information processor and clears access programs, except for the access program corresponding to the type specified by the determination, from the nonvolatile memory.

In the present invention, a plurality of access programs for accessing a storage device are prepared on the nonvolatile memory according to loadable interface or according to storage device connectable to the interface, when power is applied to the information processor, types of the loaded interface or of the storage device connected to the interface are determined, and an access program supporting to the type specified by the determination is initiated. In so doing, access program to be initiated is selected and initiated from a plurality of access program stored in the nonvolatile memory; therefore the personnel does not have to carry out operation to store only the access program to be stored in the nonvolatile memory. The personnel only have to prepare nonvolatile memory storing a plurality of access program. Therefore the necessity for preparing special facilities for the operation can be eliminated. As a result, the manufacturing cost of the information processor can be greatly reduced.

When access programs, except for the access program corresponding to the type specified by the determination, are cleared from the nonvolatile memory in preparation for the next power-on, a field in the nonvolatile memory usable for other purposes can be increased in size. By so doing, the volatile memory can be used more efficiently than before.

### BRIEF DESCRIPTION OF THE DRAWINGS

FIG. 1 is a diagram explaining a configuration of the information processor of the present embodiment;

FIG. 2 is a diagram explaining data stored in flash memory when loading;

FIG. 3 is a diagram explaining data stored in flash memory after power-on operation;

FIG. 4 is a flowchart showing processing flow performed by a mask program;

FIG. 5 is a flowchart showing processing flow performed by boot loader selection code; and

FIG. 6 is a flowchart showing processing flow performed by a loader.

### DESCRIPTION OF THE PREFERRED EMBODIMENT

In the following description, details of the preferred embodiment of the present invention are set forth with reference to drawings.

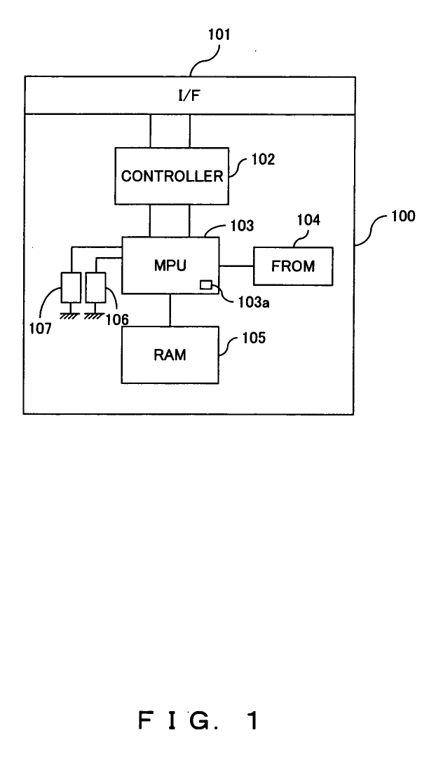

FIG. 1 is a diagram explaining a configuration of the information processor of the present embodiment.

As shown in FIG. 1, the information processor has a configuration comprising an interface (I/F) 101, which can be connected to a storage device not shown in the drawing, a hard disk controller (HDC) 102 for controlling a hard disk device connected to the I/F 100 as a storage device, an MPU 103 for controlling the entire device, flash memory 104 (represented as FROM in FIG. 1), which is nonvolatile memory, RAM 105 used as work space for the MPU 103, and electronic devices 106 and 107 each connected to a separate terminal of the MPU 103 and ground.

The electronic devices 106 and 107 are, for example, open/close switches. The switch causes all signals on the MPU 103 side to be L (low level) when closed, and to be H (high level) when open. Those signals are hereinafter referred to as “selectable bits” and a value indicated by the combination of the selectable bits is hereinafter referred to as the “boot setting value”.

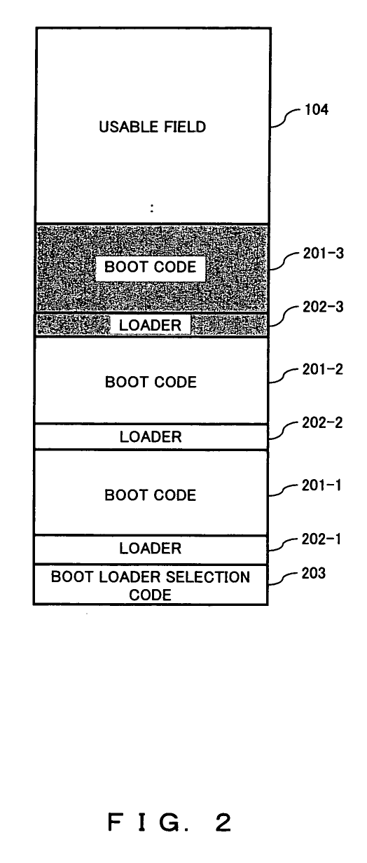

FIG. 2 is a diagram explaining data stored in flash memory when loading. In FIG. 2, boot codes 201 labeled 201-1˜3 are programs, prepared by hard disk device (storage device), for initiating a program stored on the hard disk device. Loaders labeled 202-1˜3 are programs having a function to keep the corresponding boot code 201 and to clear other boot codes 201 and loaders 202 from the flash memory 104. Boot loader selection code 203 stored at the head of the flash memory 104 is a program specifying a loader to be executed from the loaders 202-1˜3 and causing the loader to execute. The information processor of the present embodiment can be realized by an MPU 103 executing the boot loader selection code 203 stored in the flash memory 104, and executing one of loaders 202-1˜3.

An explanation of the operation with the above configuration is provided below.

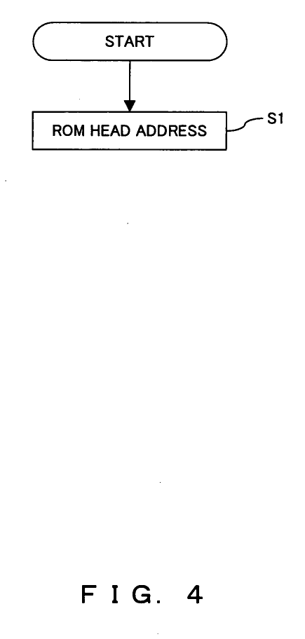

The MPU 103 comprises ROM 103a, and the ROM 103a stores a program (a mask program). The mask program is initiated at power-on operation, and the initiated mask program reads data from the head address of the flash memory 104 connected to the MPU 103, as shown in FIG. 4 (step S1). By so doing, when power-on operation is first conducted, the boot loader selection code 203 stored in the head of the flash memory 104 is initiated.

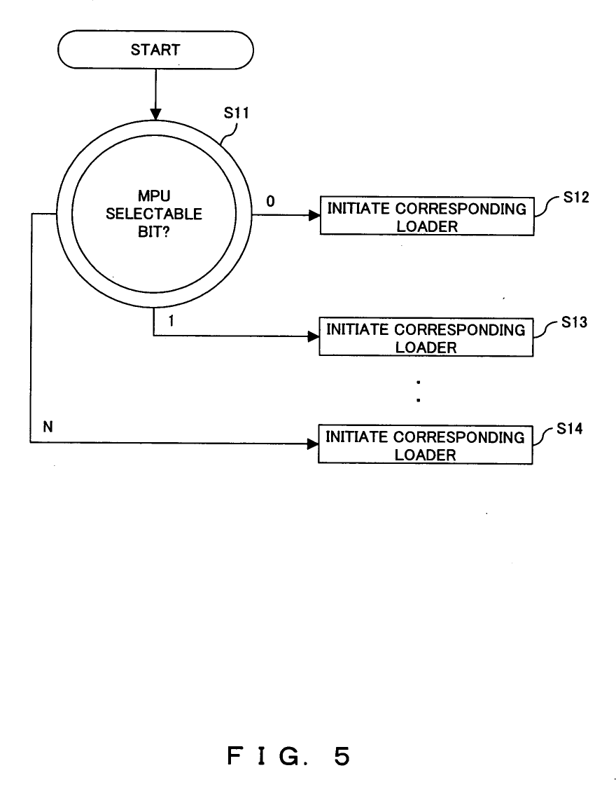

FIG. 5 is a flowchart showing processing flow performed by the boot loader selection code.

The selection code 203, when initiated, first reads the selectable bits, and determines the boot setting value, which is a value indicated by the combination of the selectable bits (step S11). When the setting value is determined to be 0, the procedure goes to step S12, and a loader 202 corresponding to the value is read from the flash memory 104 and initiated. Similarly, when the setting value is determined to be 1, the procedure goes to step S13, initiating a loader corresponding to the value, and when the setting value is determined to be N, the procedure goes to step S14, initiating a loader corresponding to the value.

In so doing, the boot loader selection code 203 determines the boot setting value set by the electronic devices 106 and 107, and initiates a loader 202 corresponding to the determination result. By so doing, personnel, performing manufacturing operation of the information processors, can execute a desired loader 202.

The number of selectable bits, that is the total number of electronic devices 106 and 107, canbe suitably determined based on the number of types of hard disk devices (or I/F 101) prepared as connection targets. Therefore, the above number N has a value larger than 3. The boot loader selection code 203, though omitted in FIG. 5, initiates the corresponding loader 202 even when the boot setting value is between 1 and N. It is also possible that initiation of the loader corresponding to the boot setting value can be realized by storing the loader 202 in a storage field set by the value.

The combination of the selectable bits is referred to for the determination of the types of hard disk devices connected to the I/F 101; however, the determination can be performed by employing other methods. For example, it is also possible that personnel input information indicating the type.

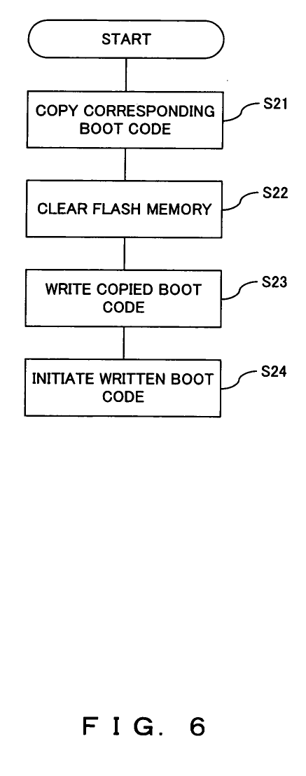

FIG. 6 is a flowchart showing the processing flow performed by a loader.

The initiated loader 202, first, copies the corresponding boot code 201 by reading from the flash memory 104 and writing to the RAM 105 (step S21). The copy can be realized by storing the corresponding boot code 201 in a storage field set by its corresponding loader 202.

Following step S21, step S22 clears the flash memory 104. In step S23 to be executed next, the copied boor code 201 is written from the head address of the flash memory 104. Subsequently, the procedure moves to step S24, and the boot code 201 written in the flash memory 104 is initiated. By the initiation of the boot code 201, programs are read from the hard disk device connected to the interface 101 and are initiated.

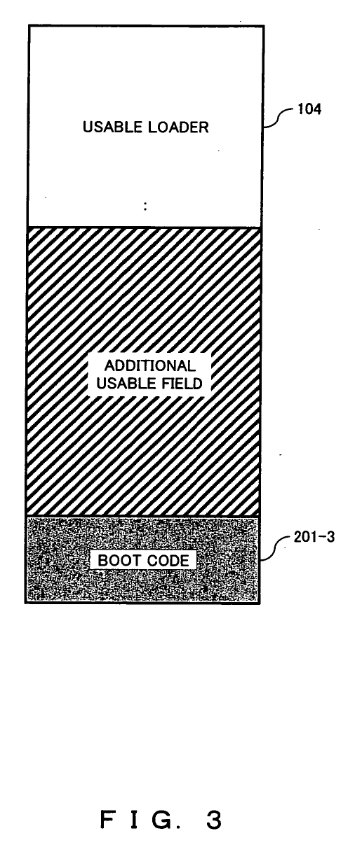

As described above, when powered-on in the state that various programs are stored in the flash memory, the boot loader selection code 203→one of the loaders 202 are initiated in sequence, a boot code 201 with a type specified by the combination of two selectable bits is newly written from the head address, and all the other boot codes 201 are cleared. As a result, the flash memory 104, as shown in FIG. 3, assumes the state where only the boot code 201 corresponding to the hard disk device connected to the interface 101 (the boot code 201-3, in this case) is stored. By so doing, when powered-on next time, the boot code 201 is initiated by the mask program. The contents of the flash memory are automatically updated from the state shown in FIG. 2 to the state shown in FIG. 3 by power-on; therefore, the necessity for personnel to use special facilities to write boot codes 201 individually to the flash memory 104 can be eliminated. The necessity for writing the boot code 201 to be written during the manufacturing process of the information processor can also be eliminated because a plurality of boot codes 201 is to be stored during the manufacturing process of the flash memory 104 in the state shown in FIG. 2 as well as a plurality of loaders 202 and the boot loader selection code 203. Consequently, the cost for facilities can be reduced, the number of work process can be reduced, and production efficiency can be improved. Thus, the manufacturing cost of the information processor can be greatly reduced.

The boot code 201 stored in the flash memory in advance may be one appropriate only to the hard disk device (or the I/F 101) assumed to be the connection target. It does not have to be corresponding to a plurality of types of hard disk devices (or I/F 101). By providing such a boot code 201, the fraction of the flash memory 104 occupied by the boot code 201 can be minimized. The remainder of the flash memory 104 may be used for other purposes such as storing firmware.

The flash memory 104, storing a plurality of boot codes 201 as well as a plurality of loaders 202 and the boot loader selection code 203, can be commonly used among a plurality of types of information processors connecting different types of hard disk devices to the I/F 101. For that reason, the number of types of flash memory 104 to be purchased or to be manufactured can be reduced. This feature facilitates response to any necessary change.

In the present embodiment, in order to keep only a boot code 201 necessary to the flash memory 104, two programs of the boot loader selection code 203 and the loader 202 are prepared for the flash memory 104; however, one program comprising the functions of the two may be prepared for the flash memory 104. If flash memory 104 with extra capacity can be loaded, a boot code 201 to be booted among a plurality of boot codes 201 can be selected and booted by storing a boot loader selection code 203 with the function of booting the boot code 201 according to the selectable bits, instead of storing the loader 202. In such a case, the work process can be further reduced, and therefore manufacturing cost can be also further reduced.

What is claimed is:

1. An information processor with which an interface on a storage device that is connectable, comprising:
nonvolatile memory storing an access program for accessing the storage device by one of a plurality of the connectable interfaces;
a type determination unit for determining the interface type; and
a program selection unit, for reading an access program, when powered-on, corresponding to the type determined by the type determination unit from the nonvolatile memory and for executing the access program.

2. The information processor according to claim 1, wherein
the program selection unit allows only the access program corresponding to the type determined by the type determination unit to execute by clearing all access programs except for the access program corresponding to the type for the nonvolatile memory when powered-on in the state that a plurality of access programs are stored in the nonvolatile memory.

3. A method for preparing an access program, accessing a storage device connected to an interface comprised in an information processor, in nonvolatile memory comprised in the information processor, wherein comprised are steps of:
loading the nonvolatile memory, storing a plurality of the access programs to a storage device connectable by the interface, in the information processor;
determining a type of a storage device connected to the interface when power is applied to the information processor; and
clearing access programs, except for an access program corresponding to the type specified by the determination, from the nonvolatile memory.
